(19) United States
(12) Patent Application Publication
(10) Pub. No.: US 2023/0322271 A1
(43) Pub. Date: Oct. 12, 2023

(54) MULTI-FACTOR TRANSITION INTO OR OUT OF AUTONOMY

(71) Applicant: Locomation, Inc., Pittsburgh, PA (US)

(72) Inventors: Albert Lorincz, LaGrange, KY (US); Richard Kark Pallo, Gibsonia, PA (US); Güliz Tokadi, Sewickley, PA (US); Lucas Renner, Washington, PA (US); Dennis Jeffrey Hoff, South Park Township, PA (US); Tekin Alp Meriçli, Pittsburgh, PA (US); Alonzo James Kelly, Edgeworth, PA (US); Michael David George, Pittsburgh, PA (US); Venkataramanan Rajagopalan, Sewickley, PA (US); Cetin Alp Meriçli, Pittsburgh, PA (US)

(21) Appl. No.: 18/093,450

(22) Filed: Jan. 5, 2023

Related U.S. Application Data
(60) Provisional application No. 63/297,349, filed on Jan. 7, 2022.

(51) Int. Cl. B60W 60/00

(52) U.S. Cl. CPC B60W 60/005; B60W 2554/00; B60W 2552/00; B60W 2555/20; B60W 2540/223; B60W 2540/12; B60W 2540/10; B60W 2420/42; B60W 2555/60; B60W 2556/65

(57) ABSTRACT

Methods and apparatus for self-driving vehicles to safely control transitions into and out of autonomy modes. The techniques may be used in a single autonomous vehicle or adapted to collaborative control of vehicles travelling in formation.

### CROSS REFERENCE TO RELATED APPLICATION TECHNICAL FIELD

This patent application claims priority to a co-pending U.S. Provisional Patent Application Ser. No. 63/297,349 filed Jan. 7, 2022, the entire contents of which are hereby incorporated by reference.

### TECHNICAL FIELD

This patent application relates to methods and systems to control and manage transitions into or out of autonomy states.

### BACKGROUND

This patent application relates to methods and apparatus used by platooning vehicles to influence the behavior of other drivers who are not part of the platoon.

Researchers and vehicle manufacturers have been developing self-driving technologies for many years. Commercial trucking continues to be one of the areas where autonomous vehicles will eventually become widespread. In one scenario, the truck at the front of a convoy remains under human control, with one or more trailing vehicles autonomously following the leader, or each other. Sensors and/or wireless connections (such as vehicle-to-vehicle radio communication) keep the trucks aware of each other's position and condition, to enable the autonomous follower(s) to respond to changes in the leader's direction and speed.

Prior art such as U.S. Pat. No. 9,690,292 B1 describe the use of “image sensors” located within the cabin (e.g., a camera, lidar, radar, or infrared) for detecting driver position/posture to determine readiness to transition out of autonomy mode.

### SUMMARY OF PREFERRED EMBODIMENTS

A method and/or apparatus for operating an autonomous vehicle to control transitions into or out of autonomy mode. The approach involves detecting a plurality of conditions regarding the state of vehicle controls and/or indicia of driver readiness and/or traffic and road conditions and/or ambient weather and lighting conditions and/or compliance with operational driving domain for autonomy. A transition into or out of autonomy mode only when two or more conditions are satisfied.

In some aspects, the techniques described herein relate to a method for operating an autonomous vehicle to control transitions into or out of autonomy mode including: detecting a plurality of conditions including a readiness state of autonomy logic, driver readiness, traffic conditions, road conditions, ambient weather conditions, ambient lighting conditions and compliance with an operational driving domain for autonomy; and transitioning into or out of an autonomy mode only when two or more of the conditions are satisfied.

In some aspects, the techniques described herein relate to a method additionally wherein the plurality of conditions persist for a determined period of time, and the driver readiness condition includes any two or more of: a driver seat in a proper position; weight on a driver seat; a steering wheel moves; the steering wheel experiences a force; the steering wheel tilts; the steering wheel is being grabbed; a fingerprint is detected on the steering wheel; a brake pedal moves; a accelerator pedal moves; an arm rest moves; and a camera confirms a driver is or is not in the driver seat.

In some aspects, the techniques described herein relate to a method and further wherein inputs from a steering wheel are ignored in an autonomy mode when a driver seat is not in a driving position or when the driver seat does not have sufficient weight to indicate a driver is present in the seat.

In some aspects, the techniques described herein relate to a method wherein the traffic conditions, the road conditions, the ambient weather conditions, the lighting conditions, and the operational driving domain restrictions do not preclude the transition.

In some aspects, the techniques described herein relate to a method wherein the autonomous vehicle is part of a formation with a second vehicle; the plurality of conditions further include approval originating from the second vehicle; and such that the transitioning into or out of the autonomy mode is a collaborative decision made between the autonomous vehicle and the second vehicle.

In some aspects, the techniques described herein relate to an apparatus for operating an autonomous vehicle to control transitions into or out of autonomy mode including: one or more data processors; and one or more computer readable media including instructions that, when executed by the one or more data processors, cause the one or more data processors to perform a process for: detecting a plurality of conditions including a readiness state of autonomy logic, driver readiness, traffic conditions, road conditions, ambient weather conditions, ambient lighting conditions and compliance with an operational driving domain for autonomy; and transitioning into or out of an autonomy mode only when two or more of the conditions are satisfied.

In some aspects, the techniques described herein relate to an apparatus wherein the plurality of conditions persist for a determined period of time, and the driver readiness condition includes any two or more of: a driver seat in a proper position; weight on a driver seat; a steering wheel moves; the steering wheel experiences a force; the steering wheel tilts; the steering wheel is being grabbed; a fingerprint is detected on the steering wheel; a brake pedal moves; a accelerator pedal moves; an arm rest moves; and a camera confirms a driver is or is not in the driver seat.

In some aspects, the techniques described herein relate to an apparatus and further wherein inputs from a steering wheel are ignored in an autonomy mode when a driver seat is not in a driving position or when the driver seat does not have sufficient weight to indicate a driver is present in the seat.

In some aspects, the techniques described herein relate to an apparatus wherein the traffic conditions, the road conditions, the ambient weather conditions, the lighting conditions, and the operational driving domain restrictions do not preclude the transition.

In some aspects, the techniques described herein relate to an apparatus wherein the autonomous vehicle is part of a formation with a second vehicle; the plurality of conditions further include approval originating from the second vehicle; and such that the transitioning into or out of the autonomy mode is a collaborative decision made between the autonomous vehicle and the second vehicle.

### BRIEF DESCRIPTION OF THE DRAWINGS

Additional novel features and advantages of the approaches discussed herein are evident from the text that follows and the accompanying drawings, where:

FIG. 1 are example semi trucks and electronic subsystems.

FIG. 2 shows some typical sensors in a truck.

FIG. 3 is an example autonomy state transition diagram.

FIG. 4 is an example block diagram of the components of a system that implements the methods and apparatus described herein.

FIG. 5 illustrates autonomy functions.

FIG. 6 illustrates propagation of a shared world model.

FIG. 7 is an example flow for a collaborative decision to transition into or out of autonomy.

### DETAILED DESCRIPTION OF ILLUSTRATIVE EMBODIMENT(S)

This patent application describes methods and apparatus for safely controlling transitions into or out of autonomy modes. Safely making such transitions is ensured by first verifying that multiple states of the vehicle and/or human driver are indicative of readiness to make the transition, and so that such transitions do not occur haphazardly. Some of the examples described here will relate to operating a single vehicle where both a human and autonomy logic may be in control. Other scenarios are described where a pair of vehicles are travelling in a formation, with a first vehicle being at least partially controllable by a human driver and a second vehicle being controllable by autonomy logic. However it should be understood that the principles discussed herein are applicable to larger groups of vehicles.

### Single Vehicle Example

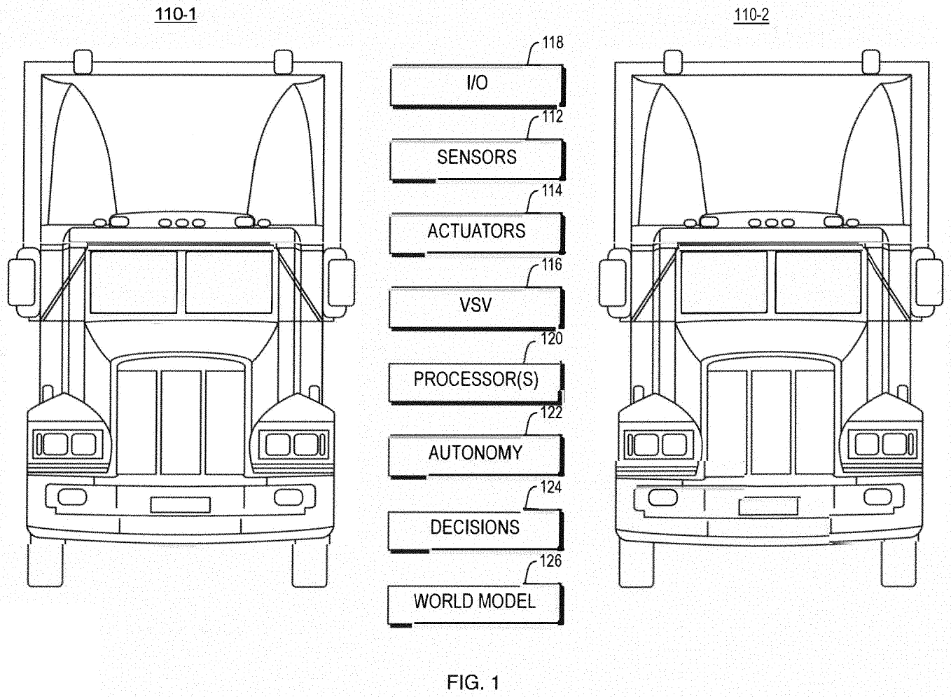

FIG. 1 illustrates an example vehicle 110-1 such as a semi-truck that includes a tractor and a fifth wheel on which the kingpin of a trailer may be coupled. In some implementations, the vehicle can be other types of vehicles such as a passenger car. The vehicle 110-1 is capable of being controlled either by a human driver or by autonomy logic.

Electronics located in the vehicle 110-1 may include sensors 112, actuators 114, V2V radio transceivers 116, other I/O devices 118, and one or more processors 120 (also referred to herein as controllers 120). As discussed further herein, the one or more processors 120 may execute various logic including autonomy logic 122, and decision logic 124. The electronics may also maintain a world model 126.

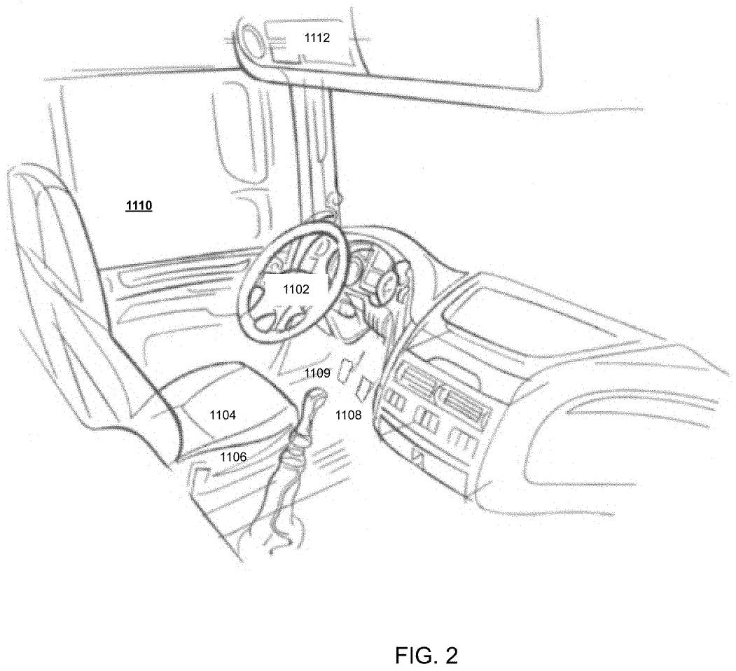

FIG. 2 is a view taken from inside the cabin of vehicle 110-1. The sensors 112 may include steering wheel 1102 sensors that detect movement of the steering wheel, or forces on the steering wheel, or even the proximity of a human hand or fingers near the steering wheel, seat sensors that detect weight and/or position of the driver's seat, arm rest position sensor 1106, throttle position 1108, or brake position 1109 sensors. A sensor 1112 such as a video or infrared camera may detect whether a human being (driver) is sitting in the seat.

Other sensors 1110 located outside of the vehicle may include cameras, lidars, radars, and the like that detect the presence of other vehicles, objects, obstacles, road condition and weather outside of vehicle 110-1. Such sensors 1110 may be used by world model logic 126 to detect acceptable external conditions conducive to transitioning into or out of autonomy.

For example, sensors 1110 and logic 126 may determine whether (i) other traffic presents no undue risks to the transitioning into or out of autonomy mode (e.g. no other vehicles are in the middle of maneuvers like lane change or overtaking) and/or (ii) the state and actions of other traffic are detectable and predictable with high enough confidence. Other example precluding conditions may include (iii) bad weather (e.g. heavy rain or snow or fog) or (iv) unacceptable road conditions (e.g., poor lane markings, road surface is irregular or slippery) or (v) vision impairment (e.g., blinding sun). The sensors may also be used to determine whether the appropriate operating driving domain conditions are present (e.g., the autonomy logic is or is not designed to operate under the prevailing conditions with reasonable certainty).

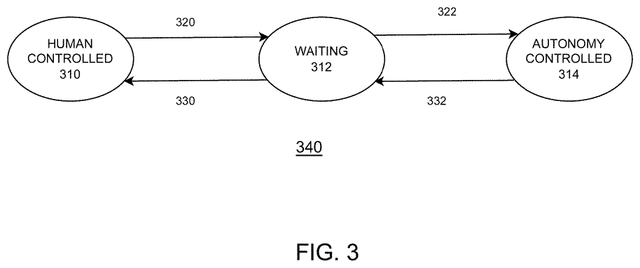

FIG. 3 is an example state transition diagram. In one state 310, the vehicle 110-1 is human-driven. In another state 314, the vehicle is controlled by autonomy logic 122. State 314 is referred to herein as autonomy-controlled. It should be understood that the autonomy may include any type or level of autonomy such as the nonzero levels of autonomy defined by the Society of Automotive Engineers (SAE).

In yet another state 312, control is in the process of transitioning between human-controlled 310 and autonomy-controlled 314, but control has not yet changed from its prior state. This state 312 is also referred to as a wait state herein.

Transitions between states include a transition 320 from human-driven 310 to the wait state 312, a transition 322 from wait state 312 to autonomy-driven 314, a transition 332 from autonomy 314 to wait 312, and a transition 330 from wait 312 to human-driven 310.

Each of these state transitions 320, 322, 330 and 332 (collectively, transitions 340) include confirmation that two or more conditions are present regarding the human and/or the vehicle components or systems or conditions external to the vehicle.

It should be understood that various sensors may be placed within the vehicle itself to sense these conditions; however certain other conditions may be reported to the vehicle via communication interfaces (such as weather conditions, or the state of another vehicle).

By way of example, any two or more of the following conditions should be persistent for a sufficient period of time (such as a least a few seconds):
(related to the vehicle itself)
seat 1104 in proper “driving position” (rotated forward, or rotated to the side, or pushed forward/back/tilted)
weight on seat 1104
steering wheel 1102 moves or experiences force(s)
steering wheel 1102 tilts
steering wheel 1102 is grabbed
authorized fingerprint detected on steering wheel 1102
brake pedal 1109 moves
accelerator pedal 1108 moves
arm rest 1106 moves up or down
camera 1112 confirms driver is or is not “in the seat”
(external to the vehicle 1110):
traffic conditions do not preclude the transition
road conditions do not preclude the transition
ambient weather and lighting conditions do not preclude the transition
(other):
operational driving domain restrictions do not preclude the transition

It should be understood, therefore, that two or more of these conditions can be structured as prerequisites for entering autonomy mode (e.g., transitions 320 and/or 322), for leaving autonomy mode (e.g, transitions 332 and/or 330) or for all such cases.

It may be prudent to use such conditions, for example, to confirm that the driver is in position, attentive, and ready to take control (the seat 1104 detects sufficient weight, the camera 1112 detects a human is in the seat with open eyes, and with hands on the wheel 1102 and brake 1109 or throttle 1108.

More generally, the presence of appropriate factors indicative of the ability to safely transition into or out of autonomy mode can involve detection of in-vehicle components such as seat position, seat weight, camera, arm rest, dashboard push buttons, steering wheel and brake pedal movement, fingerprint sensor (on the wheel), or combinations thereof. Detection may also involve determining conditions outside of the vehicle, such as traffic or weather conditions, which may be sensed by the vehicle itself or reported to the vehicle over a communication link.

In some implementations, the transitions 340 should be “smooth”. A vehicle that is capable of being both human and autonomy driven likely has propulsion, brake, and steering actuators that can be overdriven by wire commands from the controller. As such, any human inputs feed the same control inputs as the autonomy logic. Therefore, when a smooth transition 340 occurs from a human's input signal to a computer's input signal or vice versa, there will be no step or edge in that signal.

For a transition out of autonomy, the autonomy logic needs to be assured that the driver is engaged, present and can touch all the controls, whatever those constraints are.

Another scenario occurs when the autonomy is in control and expects no human input—that is, nothing should be touching the wheel, or the brake, or the throttle. The multi-factor control flow can be used to provide an interlock that prevents undesirable loss of control. For example, if something does touch one of the control inputs (such as cat jumping into the driver's seat, or a human brushing against the wheel while leaving the drivers set, or perhaps a cell phone drops onto the brake because of a bump in the road, the transition out of autonomy will be prevented.

The different factors can also be evaluated in a sequence over a predetermined period of time such as several seconds and, if necessary, filtered to reject momentary noise or transients in the signals. For example, if a human only yanks on the wheel, or only sits in the seat, the transition will not occur. For example, the transitions 340 may require multiple factors such as more than 100 pounds on the seat, a tug on the wheel, the camera sensing a human body in the seat, and the fingerprint sensor determining an authorized person is touching the wheel.

In another case, the position of the arm rest 1106 sensor may be used in combination with the seat 1104 sensor. If the arm rest flips up and weight on the seat suddenly drops, the transition logic can determine that the driver is getting out of the seat.

Another case occurs while the vehicle is in autonomy mode and driver is not in the seat and elsewhere in the cab, perhaps resting. A pet or some other object touches the steering wheel or falls on the seat. The multi-factor transition logic can thus prevent inadvertently transition out of autonomy mode when there is no human driver ready and able to take over.

The multi-factor transition logic can also reduce the risk of misinterpreting signals from a single sensor. For example, the camera 1112 logic may conclude that a human is in the seat when in fact it is a large dog.

Multi-Factor Autonomy Transitions as Part of Collaborative Control of Vehicles Travelling in Formation

Briefly returning attention to FIG. 1, the same multi-factor control over autonomy transitions may be utilized where multiple vehicles are cooperatively travelling in formation.

When vehicles desire to move in formation, each may have access to information that others may not. The information available in any vehicle might originate in or near the vehicle and be sensed using sensors on that vehicle. The physical phenomena being sensed might be too far away from other vehicles to sense (either well or at all) or the phenomena may be occluded by the one vehicle able to sense it. Information may also originate from a human inside any vehicle whose presence is unknown or undetectable in other vehicles. When humans are the intended consumer of information it often is best formatted in a manner consistent with human sensory capacities. Information could also be the result of arbitrary amounts of processing of any other information that was available as inputs to such processing.

When a number of vehicles desire to act as a unit, they will often need to think as a unit, and this can be difficult to achieve when all of the relevant information is distributed across space—meaning among the vehicles themselves. One possible solution is to share relevant information among the vehicles. The approach does not rely on particular signal processing, simulation, sensor data fusion, or optimal estimation schemes, but rather in the methods to interpolate, extrapolate, deconflict, filter, process and share such information as part of collaborative decision making. A shared database produced using such techniques can be more complete, up-to-date, consistent, and accurate than it might be otherwise and this database can be made available on every vehicle.

Methods are presented herein to share information in order to enable and/or improve the manner in which a number of vehicles may operate in formation as a unit. Individual vehicles may be operated by humans, by autonomy logic, or by a combination of both. For example, autonomy logic may be used to offload humans, cognitively or otherwise, to allow the human(s) to focus attention elsewhere or relieve them from the need to communicate with vehicles in sufficiently quantitative or precise terms.

Furthermore, some methods may use information being shared between all of the humans and all of the autonomy logic on all of the vehicles in order to enable the entire formation to operate more effectively as a unit.

Returning attention to FIG. 1, shown there is a situation where two vehicles are cooperatively travelling in a formation as a unit. An example formation may be a convoy, or even a platoon where the vehicles are following closely. Both vehicles may incorporate, either when the vehicle is manufactured or in a subsequent retrofit, hardware and software that enables them to implement autonomy logic. Such autonomy logic may include algorithms to enable vehicles to drive themselves, to interact with human drivers, and to exchange information between themselves.

In this case, both example vehicle 110-1, 110-2 may include sensors 112, actuators 114, V2V radio transceivers 116, other I/O devices 118, and one or more processors 120 (also referred to herein as controllers 120).

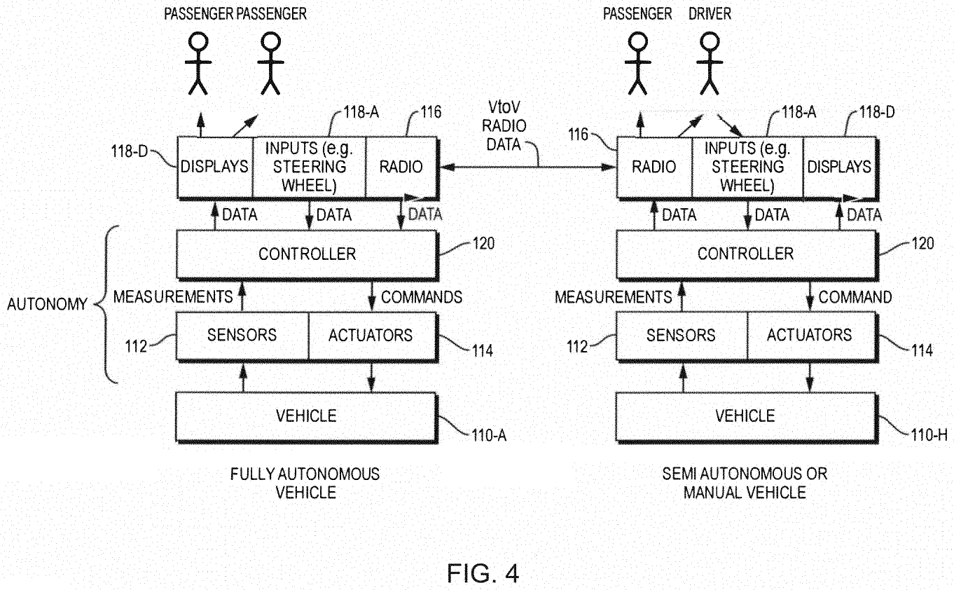

FIG. 4 illustrates these components in more detail. Self-driving algorithms and other aspects of the autonomy logic 122 are implemented in a controller (such as one or more processors 120) that receives sensor 112 data from the respective vehicle (110-1 or 110-2) and sends actuator 114 signals to the respective vehicle 110-1 or 110-2. The controller 120 may further implement human interface algorithms that accept inputs (e.g., steering, throttle, touch screen etc.) via other I/O devices 118-D from human drivers while also sending data to other I/O devices 118 such as human-readable displays. The controller 120 may also send data to and accept data from vehicle-to-vehicle (V2V) radio transceiver(s) 116 to allow it to interact with humans and exchange information with the controllers 120 located in other vehicles 110.

Collaboration Via Shared Information

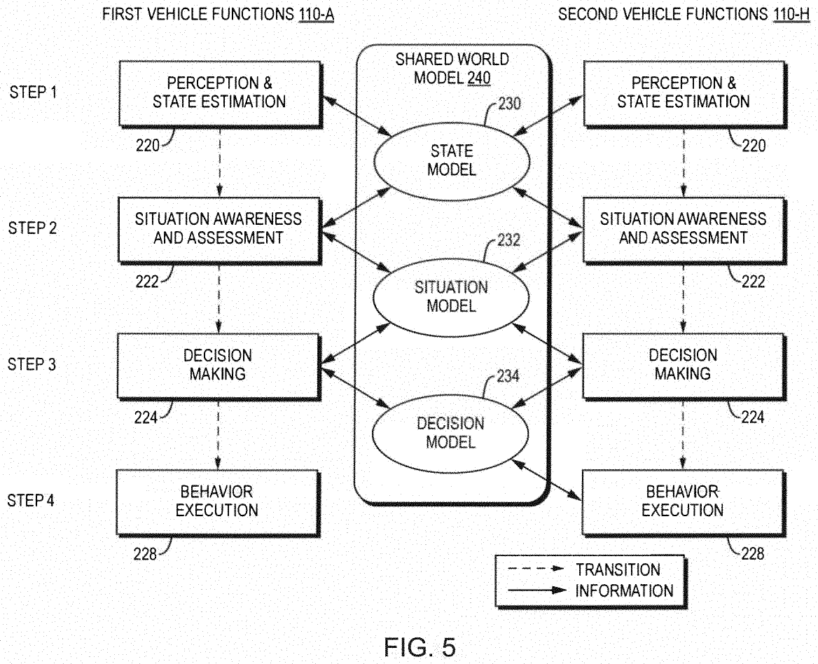

As shown in FIG. 5, functions that provide decision logic 124 for each vehicle 110-A, 110-H may include perception and state estimation 220, situation awareness and assessment 222, decision making 224, and behavior execution 228. The world model 126 may include a state model 230, situation model 232 and decision model 234.

The controller 120 may implement algorithms that enable driver(s) and vehicles to collaborate based on the shared information. This information typically includes sensor data originating outside the components of the computer/human system as well as derived data (states, events, constraints, conclusions) originating inside the computer/human system and data indicative of physical phenomena created by human drivers or for the purpose of being sensed by human drivers. The shared information may therefore include data that (i) originates within or outside the convoy, (ii) represents physical phenomena (such phenomena produced by or capable of being sensed by humans, such as forces on steering wheels), (iii) is received from sensors or other input devices in its raw/sensed form or (iv) is derived data (examples include states, events, constraints, conclusions, originating inside the components of autonomy logic or human control).

Each vehicle 110 will have its own local copy 126 of such shared information referred to herein as a shared world model 240. At any given instant, each local copy 126 of the shared world model 240 may not be entirely consistent with the local copy 126 on other vehicles. Nevertheless, processes residing on all controllers 120 for all vehicles 110 attempt to keep the shared information in the shared world model 240 and local copies 126 sufficiently up-to-date and consistent to permit effective collaboration. Propagation of the local copy 126 of the shared world model 240 among vehicles 110 is discussed in more detail below.

In FIG. 5, the rectangular boxes on both left and right sides indicate an example sequence called a perceive-think-act sequence. The dotted lines represent transitions between processing steps for the information flow that supports the decision making. As data that originates inside the computer/human system, the world model 126 (and hence also the shared world model 240) acts as another source of information to be used by the autonomy algorithms implemented in the controller 120.

The perception and state estimation step 220 may process all of the information incoming from all sources in order to derive substantially new information that describes arbitrary attributes of the vehicles, humans, and external objects and traffic, etc. Such processing may comprise operations such as, for example:
state estimation/data fusion—reducing redundant information to non-redundant form or combining relevant quantities to produce other relevant quantities (e.g. measuring space between the vehicles)
prediction—deriving later state from earlier state and a measurement (or prediction) of time (e.g. predicting time to collision based on last known speed)

The situation awareness and assessment step 222 may process all of the information incoming from all sources in order to derive substantially new information that is less directly related to sensed and communicated information, for example:
detecting events—watching and noticing when something important occurs (e.g. car in blind spot)
constraint propagation—deriving constraints from other information (e.g. do not change lanes now)

The decision making step 224 may process all of the information incoming from all sources in order to derive substantially new information that is associated with or comprises decision making, for example:
logic—deriving conclusions from other information, typically by the processes of logical inference, deduction, resolution etc. (e.g. proposed lane change is rejected due to incoming veto)
deliberation—weighing numerous alternatives in order to choose one of them (e.g. first vehicle cannot speed up so second vehicle should slow down)

The behavior execution step 228 may process all of the information incoming from all sources in order to derive substantially new information that is associated with or causes acting in the real world, for example:
notification—creating events (e.g. messages) for consumption in another part of the system (e.g. lane change maneuver commencing now)
action—maintaining or altering the motion of the vehicle (e.g. execution of emergency braking maneuver.

Shared World Model

In FIG. 5, the ellipses 230, 232, 234 indicate some components of the shared world model 240. The shared world model 240 is used as a diverse data repository that is both the source of relevant information for some algorithms, and the repository for results for other (or the same) algorithms. In general, any processing step may read information from or write information to any component. As mentioned above, each vehicle has its own local copy 126 of the shared world model 240 and processes attempt to keep them somewhat up-to-date and consistent. In this way, processes on any one vehicle are effectively reading and writing information to the shared world models of all vehicles.

The shared world model 240 comprises all information that is shared. In FIG. 5, it was depicted as being divided into three components 230, 232, 234 for convenience of explanation but there can be more or fewer components (such as state prediction 321 described below) and the distinctions between them only serve to help elaborate the different ways in which vehicles may collaborate. In an example embodiment, the shared information contains:
State model 230—information that relates to the properties, attributes, etc. of all objects of interest, both internal and external to the vehicle formation. For example, this component comprises aspects of “where everything is and how it is moving”.
Situation model 232—information that relates to description of the situation. For example, this component comprises aspects of “what is happening”.
Decision model 234—information that relates to decisions to taking or not taking actions. For example, this component comprises aspects of “what to do”.

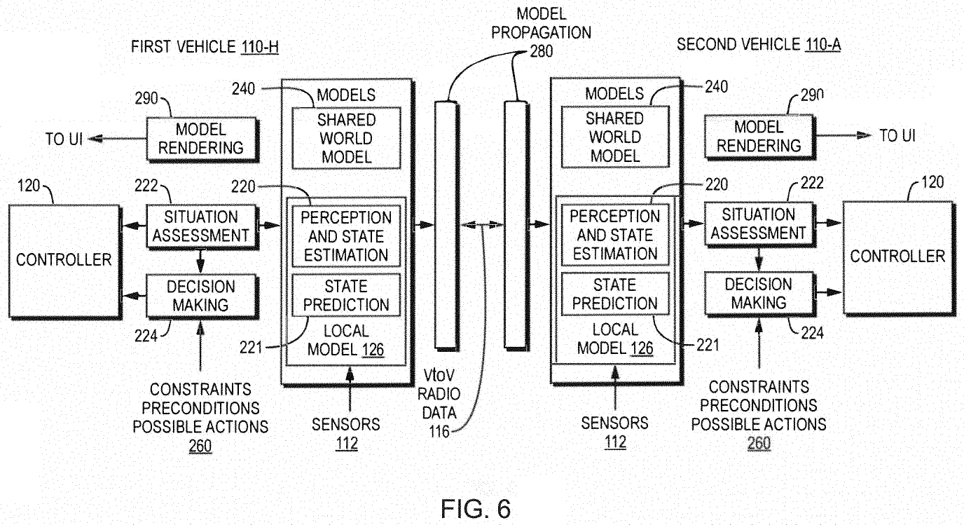

As depicted in the example data flow diagram of FIG. 6, each vehicle 110 has a controller 120, local model 126, perception and state estimation 220, state prediction 221, situation assessment 222, decision making 224, shared world model 240, model propagation 280, model rendering 290, and vehicle to vehicle communication 295 components.

Sensors 112 feed the perception and state estimation 220 and state prediction 221 components that make up the local model 126. The content of the local model 126 is used to develop the local copy of the shared world model 240 which is in turn shared with other vehicles 110 via the model propagation function 280. Constraints, preconditions and possible actions 260 are input to decision making 224 along with outputs from situation assessment 222, which in turn drive the controller 120. Model rendering 290 feeds a user interface.

Collaborative Decision to Enter or Leave Autonomy

The information shared between vehicles, be it via a vehicle-to-vehicle communication devices such as transceiver 116 or via a shared world model 240 can be used to implement collaborative behaviors. Such collaborative behaviors may require approval from a companion vehicle before a particular action is taken.

For example, the transfer of control into or out of autonomy mode may be a collaborative behavior. To enable this collaborative behavior, the shared world model 240 may include relative distance and relative speed information for the vehicles as well as information about a request from one vehicle (who might be the lead vehicle in a formation) to another vehicle to join the formation in autonomy mode. That request is processed to assess compliance with pre-conditions on the transition of one or both vehicles into autonomy mode. Some or all of the information needed to assess pre-conditions may be provided in the shared world model 240 itself. For example, information related to the state of sensors in their respective vehicles may be stored in the world model 240. The preconditions may also be used to orchestrate a deliberate handshaking maneuver where a request issued by a human in one of the vehicles is ultimately processed and perhaps accepted by a human in the other vehicle. The result is that a decision to enter autonomy is a collaborative one, involving decisions by the operators or autonomy logic in both vehicles, and is based on the multi-factor pre-conditions presented above.

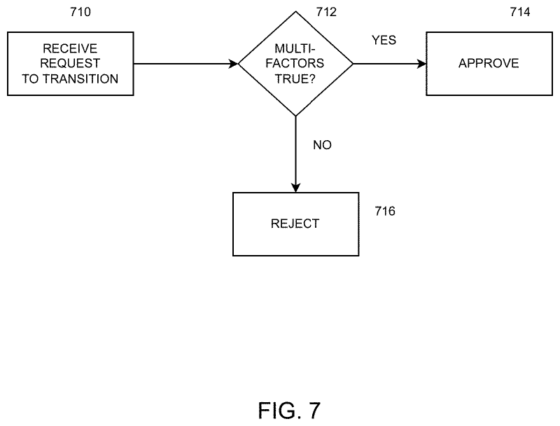

FIG. 7 is an example flow for such a collaborative decision. In a first state 710, a vehicle 110-1 currently under human control receives a request from another vehicle 110-2 to enter autonomy mode. In state 712, the logic in vehicle 110-1 determines whether two or more conditions indicative of the ability to safely transition are present.

If so, in state 714, approval of the transition is communicated back to vehicle 110-2.

If not, in state 716, rejection of the request to transition is communicated back to vehicle 110-2.

### IMPLEMENTATION OPTIONS

The foregoing description of example embodiments illustrates and describes systems and methods for implementing novel arrangement and operation of sensors in a vehicle. However, it is not intended to be exhaustive or limited to the precise form disclosed.

The embodiments described above may be implemented in many different ways. In some instances, the various “computers” and/or “controllers” are “data processors” or “embedded systems” that may be implemented by a one or more physical or virtual general purpose computers having a central processor, memory, disk or other mass storage, communication interface(s), input/output (I/O) device(s), and other peripherals. The general purpose computer is transformed into the processors with improved functionality, and executes program code to perform the processes described above to provide improved operations. The processors may operate, for example, by loading software instructions, and then executing the instructions to carry out the functions described.

As is known in the art, such a computer may contain a system bus, where a bus is a set of hardware wired connections used for data transfer among the components of a computer or processing system. The bus or busses are shared conduit(s) that connect different elements of the computer system (e.g., processor, disk storage, memory, input/output ports, network ports, etc.) to enables the transfer of information. One or more central processor units are attached to the system bus and provide for the execution of computer instructions. Also attached to system bus are typically I/O device interfaces for connecting various input and output devices (e.g., sensors, lidars, cameras, keyboards, touch displays, speakers, wireless radios etc.) to the computer. Network interface(s) allow the computer to connect to various other devices or systems attached to a network. Memory provides volatile storage for computer software instructions and data used to implement an embodiment. Disk or other mass storage provides non-volatile storage for computer software instructions and data used to implement, for example, the various procedures described herein.

Certain portions may also be implemented as “logic” that performs one or more of the stated functions. This logic may include hardware, such as hardwired logic circuits, an application-specific integrated circuit, a field programmable gate array, a microprocessor, software, firmware, or a combination thereof. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

Embodiments may therefore typically be implemented in hardware, firmware, software, or any combination thereof.

In some implementations, the computers or controllers that execute the processes described above may be deployed in whole or in part in a cloud computing arrangement that makes available one or more physical and/or virtual data processing machines via on-demand access to a network of shared configurable computing resources (e.g., networks, servers, storage, applications, and services) that can be rapidly provisioned and released with minimal management effort or service provider interaction.

Furthermore, firmware, software, routines, or instructions may be described herein as performing certain actions and/or functions. It also should be understood that the block and flow diagrams may include more or fewer elements, be arranged differently, or be represented differently. Therefore, it will be appreciated that such descriptions contained herein are merely for convenience and that such actions in fact result from computing devices, processors, controllers, or other devices executing the firmware, software, routines, instructions, etc.

While a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The above description contains several example embodiments. It should be understood that while a particular feature may have been disclosed above with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

Accordingly, the subject matter covered by this patent is intended to embrace all such alterations, modifications, equivalents, and variations that fall within the spirit and scope of the claims that follow.

1. A method for operating an autonomous vehicle to control transitions into or out of autonomy mode comprising:
detecting a plurality of conditions including a readiness state of autonomy logic, driver readiness, traffic conditions, road conditions, ambient weather conditions, ambient lighting conditions and compliance with an operational driving domain for autonomy; and
transitioning into or out of an autonomy mode only when two or more of the conditions are satisfied.

2. The method of claim 1 additionally wherein the plurality of conditions persist for a determined period of time, and the driver readiness condition includes any two or more of:
a driver seat in a proper position;
weight on a driver seat;
a steering wheel moves;
the steering wheel experiences a force;
the steering wheel tilts;
the steering wheel is being grabbed;
a fingerprint is detected on the steering wheel;
a brake pedal moves;
a accelerator pedal moves;
an arm rest moves; and
a camera confirms a driver is or is not in the driver seat.

3. The method of claim 1 and further wherein inputs from a steering wheel are ignored in an autonomy mode when a driver seat is not in a driving position or when the driver seat does not have sufficient weight to indicate a driver is present in the seat.

4. The method of claim 1 wherein the traffic conditions, the road conditions, the ambient weather conditions, the lighting conditions, and the operational driving domain restrictions do not preclude the transition.

5. The method of claim 1 wherein
the autonomous vehicle is part of a formation with a second vehicle;
the plurality of conditions further include approval originating from the second vehicle; and
such that the transitioning into or out of the autonomy mode is a collaborative decision made between the autonomous vehicle and the second vehicle.

6. An apparatus for operating an autonomous vehicle to control transitions into or out of autonomy mode comprising:
one or more data processors; and
one or more computer readable media including instructions that, when executed by the one or more data processors, cause the one or more data processors to perform a process for:
detecting a plurality of conditions including a readiness state of autonomy logic, driver readiness, traffic conditions, road conditions, ambient weather conditions, ambient lighting conditions and compliance with an operational driving domain for autonomy; and
transitioning into or out of an autonomy mode only when two or more of the conditions are satisfied.

7. The apparatus of claim 6 wherein the plurality of conditions persist for a determined period of time, and the driver readiness condition includes any two or more of:
a driver seat in a proper position;
weight on a driver seat;
a steering wheel moves;
the steering wheel experiences a force;
the steering wheel tilts;
the steering wheel is being grabbed;
a fingerprint is detected on the steering wheel;
a brake pedal moves;
a accelerator pedal moves;
an arm rest moves; and
a camera confirms a driver is or is not in the driver seat.

8. The apparatus of claim 6 and further wherein inputs from a steering wheel are ignored in an autonomy mode when a driver seat is not in a driving position or when the driver seat does not have sufficient weight to indicate a driver is present in the seat.

9. The apparatus of claim 6 wherein the traffic conditions, the road conditions, the ambient weather conditions, the lighting conditions, and the operational driving domain restrictions do not preclude the transition.

10. The apparatus of claim 6 wherein
the autonomous vehicle is part of a formation with a second vehicle;
the plurality of conditions further include approval originating from the second vehicle; and
such that the transitioning into or out of the autonomy mode is a collaborative decision made between the autonomous vehicle and the second vehicle.
